(19) United States
(12) Patent Application Publication
(10) Pub. No.: US 2011/0278034 A1
(43) Pub. Date: Nov. 17, 2011

(54) PORTABLE ANGLE IMPACT TOOL

(75) Inventors: Wei Song, Nanjing (CN); Xiaoyong Wang, Nanjing (CN); Xiang Zhao, Nanjing (CN)

(73) Assignee: Chervon Limited, Wanchai (HK)

(21) Appl. No.: 12/832,556

(22) Filed: Jul. 8, 2010

(30) Foreign Application Priority Data
May 11, 2010 (CN) 201010168747.X

(51) Int. Cl. B25D 11/04

(52) U.S. Cl. 173/93.5

(57) ABSTRACT

A portable angle impact tool includes a housing, a motor, and a transmission mechanism. The transmission mechanism includes a transmission rod extending along an axis X, a spindle extending along an axis Y perpendicular to the axis X, an impact assembly for driving an output shaft and connected with the spindle, a first transmission element positioned on the transmission rod and engaging with a second transmission element positioned on the spindle, and a pinion positioned on of the transmission rod engaging with a gear on a motor shaft of the motor. In a direction of the axis Y, the impact assembly and the spindle are located on one side of the second transmission element and the longitudinal axis X of the transmission rod is located on the other side of the second transmission element to provide the impact tool with a more compact arrangement and higher output power from the output shaft.

### RELATED APPLICATION INFORMATION

This application claims the benefit of CN 201010168747.X filed on May 11, 2010 the disclosure of which is incorporated herein by reference in its entirety.

### BACKGROUND

This disclosure generally relates to portable tools and, more particularly, to a portable angle impact tool.

The portability and output power of portable tools, particularly portable tools in the form of impact drivers, impact wrenches, and impact drills, are given more and more attention. In this regard, the dimension of the whole tool is an important factor for evaluating the portability of the tool. To take impact drivers for example, the motor shafts of currently available, portable impact drivers are arranged substantially in a same line with the spindle so that these impact drivers have longer main bodies. Thus, while these impact drivers may be portable, these impact drivers remain inconvenient for users to operate, for example, with users not being able to use such impact drivers in relatively narrow spaces.

To solve the above problem, angle impact drivers have been proposed which have a transmission mechanism made of two portions that are arranged perpendicular to each other so as to shorten the length of the main body. By way of example, an angle impact driver is shown in FIG. 1 as having a relative small working head 122 wherein a motor shaft is arranged perpendicular to a working output shaft so as to reduce the space of the main body. However, because the impact structure is located near the motor in the lower portion of the main body and away from the working output shaft, this arrangement suffers the disadvantage that the impact energy generated by the impact structure is consumed much more during the transmission process to the working output shaft via the next stage of transmission device that is positioned after the impact structure.

### SUMMARY

The following describes an improved portable angle impact tool. More particularly, the described portable angle impact tool comprises a housing, a motor arranged within the housing, and a transmission mechanism which comprises a transmission rod extending along a longitudinal axis X, a spindle extending along an axis Y perpendicular to the axis X, an impact assembly, and an output shaft connected with the spindle. A first transmission element is arranged on one end of the transmission rod and is engaged with a second transmission element that is arranged on one end of the spindle. A pinion is arranged on the other end of the transmission rod and is engaged with a gear that is arranged on a motor shaft. In the direction of the axis Y the impact assembly and the spindle are located on one side of the second transmission element and the longitudinal axis X of the transmission rod is located on the other side of the second transmission element. In this manner, the arrangement of the first transmission element on the transmission rod engaged with the second transmission element on the spindle on the other side away from the impact assembly functions to save space and make the structure compacter while allowing the impact structure to act upon the output shaft directly thus increasing the efficiency and torsion of the tool.

### BRIEF DESCRIPTION OF THE DRAWINGS

FIG. 1 is a schematic view illustrating a portable angle impact driver;

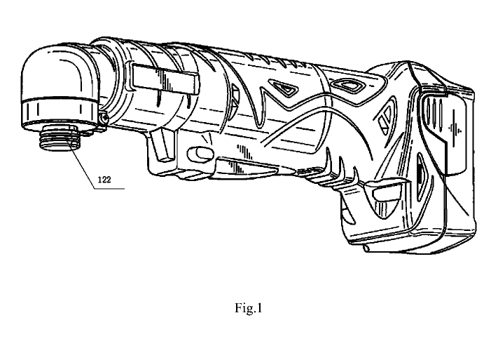

FIG. 2 is an exploded view illustrating a portable angle impact tool constructed according to the description that follows;

FIG. 3 is a partial sectional view illustrating the whole appliance of the portable angle impact tool shown in FIG. 2;

FIG. 4 is a schematic view illustrating the structure of a transmission mechanism shown in FIG. 3;

FIG. 5 is a schematic view illustrating the structure of an impact assembly and an output shaft of the portable angle impact tool shown in FIG. 2;

FIG. 6 is a schematic view illustrating the transmission mechanism shown in FIG. 3, which is rotated clockwise by 90° about a motor shaft;

FIG. 7 is a schematic view illustrating the transmission mechanism shown in FIG. 3, which is rotated counterclockwise by 90° about the motor shaft;

FIG. 8 is a schematic view illustrating a housing of the portable angle impact tool shown in FIG. 2;

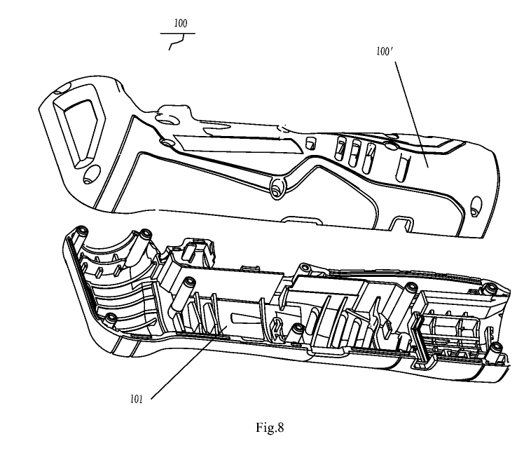

FIG. 9 is a schematic view illustrating the structure of a switch assembly of the portable angle impact tool shown in FIG. 2; and

FIG. 10 is an exploded view illustrating the switch assembly shown in FIG. 9.

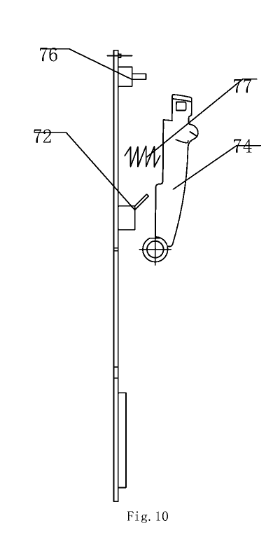

### DETAILED DESCRIPTION

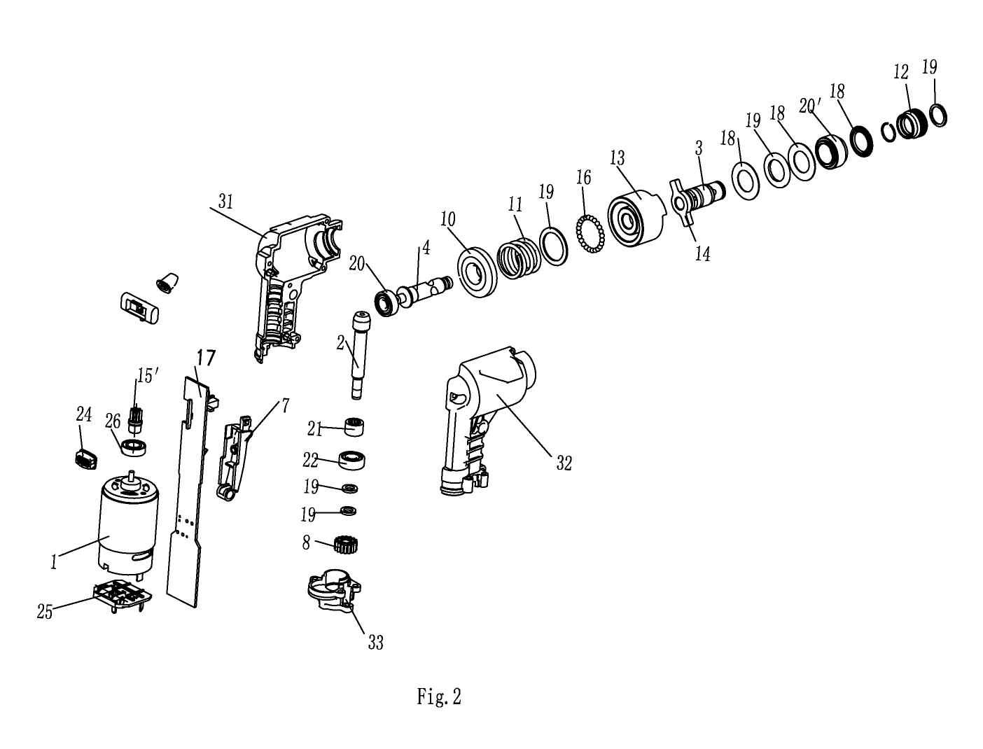

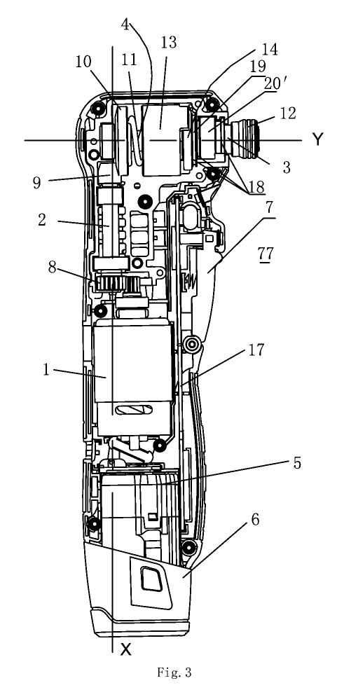

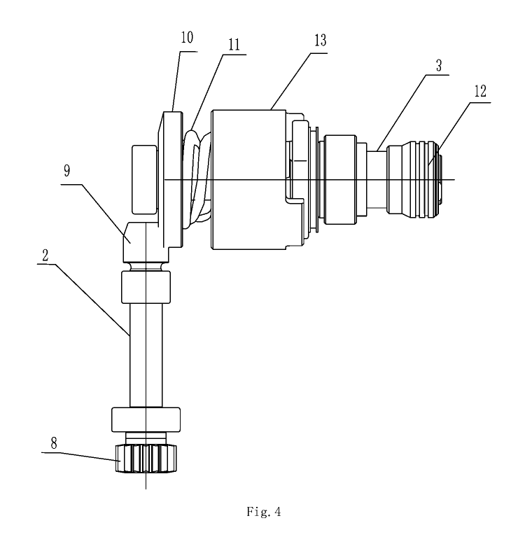

As shown in FIGS. 2-7, a portable angle impact tool of a preferred embodiment comprises a housing 100, a battery 5, a transmission mechanism fixed within an upper inner space of the housing 100, and a motor 1 fixed within a middle inner space of the housing 100. The housing 100 of the angle impact tool comprises a main body 100′ and a battery pack housing 6. The main body 100′ is structured to be two parts, which comprises a first housing body 101 and a second housing body 101′ which could be mated together. The first housing body 101 and the second housing body 101′ can be mated to form a space for receiving the inner parts of the tool therein. A portion of the battery 5 is positioned within the battery pack housing 6 to form a battery pack which can be detachably connected to the main body 100′. When the battery pack is connected to the main body of the housing, the other portion of the battery 5 exposed out of the battery pack housing 6 is located within the main body 100′, thereby the battery 5 is located in a lower inner space within the housing 100. The motor 1 is located between the transmission mechanism and the battery. The outer surfaces the battery pack housing 6 and the main body 100′ of the housing which are adjacent to each other are shaped to be smoothly transitioned so as to ensure the consistency and integrity of the shape of the housing 100.

One of ordinary skill in the art could understand easily that in other embodiments the housing may have other arrangements and structures and the battery 5 may be designed as a built-in type that is fixed within the housing.

The transmission mechanism comprises a transmission rod 2 extending along a longitudinal axis X, a spindle 4 extending along an axis Y which is perpendicular to the axis X, an impact assembly and an output shaft 3. A first transmission element 9 is arranged on a top end of the transmission rod 2 and a pinion 8 is arranged on a bottom end thereof. The motor 1 has a motor shaft 15, on which a motor gear 15′ is engaged with the pinion 8. A motor bearing 26 and the motor gear 15′ are located on the output shaft 15 of the motor. A connecting bracket 25 is arranged on a lower portion of the motor 1. The motor gear 15′ may be directly formed on the motor shaft 15 or be a separate gear mounted onto the motor shaft 15 in various embodiments. The pinion 8 is mounted onto the transmission rod 2 which passes through a second bearing 21, a third bearing 22, and one or more spacers 19. A second transmission element 10 is arranged on one end of the spindle 4 and an impact block 13 is arranged on the other end thereof. An impact restoring mechanism is positioned between the impact block 13 and the second transmission element 10. A first bearing 20 is located on the other side of the second transmission element 10. The impact block 13 is connected to the spindle through an impact connecting device constructed of steel balls 16 and grooves. Preferably, the impact restoring mechanism is a compressed spring 11 that encloses the spindle 4. In other embodiments, the impact restoring mechanism may be springs of other suitable types or magnetic mechanisms and so on, and the mounting position is not limited to enclosing the spindle. Preferably, the second transmission element 10 and the first transmission element 9 are both helical gears, wherein the teeth number of the second transmission element 10 is larger than that of the first transmission element 9 and wherein the diameter of the second transmission element 10 is larger than that of the first transmission element 9. In other embodiments, the first transmission element and the second transmission element may also be the transmission assemblies of worm gear and worm gear or bevel gear and bevel gear. The impact block 13 and the spindle 4 have the common central axis Y. A hammer anvil 14 which is connected to the output shaft 3 is arranged on one side of the impact block 13 removed from the spring 11. A bushing 12 is arranged on the output shaft 3.

The impact assembly comprises the impact restoring mechanism, the impact block 13, and the hammer anvil 14. Preferably, the impact assembly and the spindle 4 have the common axis Y. The first transmission element 9 on the transmission rod 2 is engaged with the second transmission element 10 on the spindle 4 on the other side of the second transmission element removed from the impact block 13 so that the space of the angle impact tool on the side of the impact block 13 can be efficiently utilized to thereby enable the structure to be more compact with decreased dimensions.

In operation, the transmission rod 2 transmits the rotation movement output from the motor 1 to the second transmission element 10 on the spindle 4 via the first transmission element 9 on the top end of the transmission rod 2, so that the direction of the rotation movement is changed from rotating about the axis X in which the transmission rod 2 is located to rotating about the axis Y in which the spindle 4 is located. The impact connecting mechanism between the spindle 4 and the impact block 13 makes the spindle 4 drive the impact block to rotate about the axis Y while producing an axial impact motion along the Y axis, and finally to provide the rotation and impact to the output shaft 3. By this arrangement, the impact energy generated from the impact assembly is transmitted directly to the output shaft 3 so that the impact torsion of the angle impact tool is larger and the working efficiency is higher.

Along the axis Y, the hammer anvil 14 is locked on the output shaft 3 by a filler 20′ and a retainer ring 18 to achieve the connection with the output shaft 3. The filler 20′ is a metallic member having a through hole in the middle for supporting the hammer anvil 14, which is preferably solid except for the through hole. Compared with the bearing usually used for rotary support, the metallic filler resists the impact better. The bushing 12 is arranged on the end of the output shaft 3, which is used for receiving and detachably securing various working components adapted for the angle impact tool. Preferably, the angle impact tool is an angle impact driver and the working component is preferably a screwdriver bit. The bushing 12 would thus have a structure adapted to retain the screwdriver bit. In other embodiments, the bushing 12 could also be made into a structure that is adapted to retain the working components of an impact wrench or impact drill.

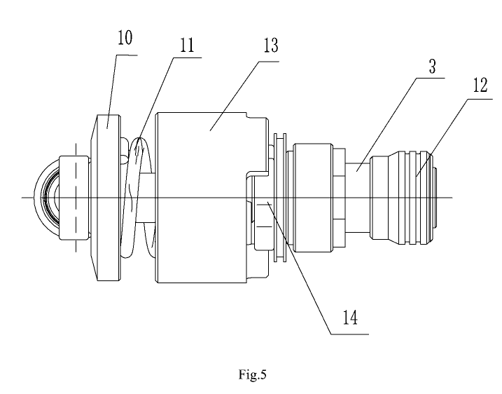

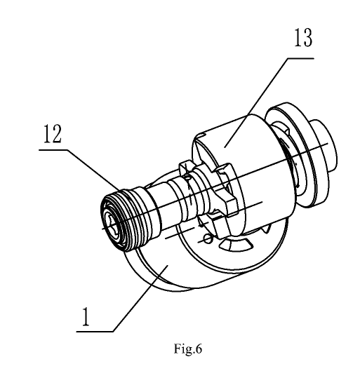

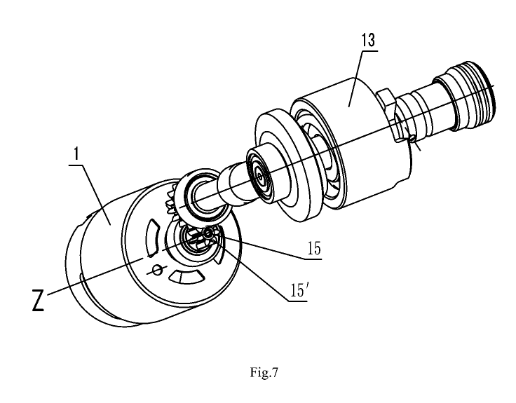

As a further improvement, the transmission mechanism could rotate about the central axis Z of the motor shaft 15, and be selectively stopped and secured in one of a first position, a second position and a third position. As shown in FIGS. 6 and 7, which uses the same reference numerals as those in the forgoing drawings to indicate the same components, the axis X of the transmission rod 2 is parallel to the axis Z of the motor shaft 15. Along the rotation direction about the axis Z, the second position and the first position, as well as the first position and the third position, are each spaced from each other by ninety degrees. FIG. 5 shows the transmission mechanism located in the first position. FIG. 6 shows that the transmission mechanism rotated counterclockwise by 90° about the axis Z from the first position shown in FIG. 5 to the second position. FIG. 7 shows that the transmission mechanism rotated clockwise by 90° about the axis Z from the first position shown in FIG. 5 to the third position.

To provide for the rotation of the transmission mechanism between the first position, the second position, and the third position relative to the motor shaft, the main body 100′ of the housing is divided into two sections along the direction of the axis Z. A rotation connecting portion and a securing device are arranged between the connection of the two sections of the main body 100′ of the housing to achieve the relative rotation and fixation between the upper and lower sections of the main body 100′ of the housing. By means of the gear box housing, the transmission mechanism is secured within the upper section of the main body 100′ of the housing and the motor 1 is secured within the lower section of the main body 100′ of the housing. During normal operation, the transmission mechanism is positioned in the first position relative to the motor shaft. When necessary, the users could achieve the relative rotation of the transmission mechanism relative to the motor shaft by rotating the lower and upper sections of the main body 100′ of the housing relatively. The securing device could achieve the relative fixation between the upper and lower sections of the main body 100′ of the housing at least in the first position, the second position, and the third position. One ordinary skilled in the art could also envisage that the transmission mechanism may also be selectively secured only in the first position and the second position, or only in the first position and the third position relative to the motor output shaft in other embodiments. The connecting bracket 25 is designed such that, by the respective engagement of its protrusions with grooves in the lower portion of the motor and in the upper portion of the battery, the connections between the three parts are steadier.

Referring to FIG. 2, in the portable angle impact tool, the gear box comprises a three-piece gearbox housing which consists of a left piece (a first gearbox housing part 31), a right piece (a second gearbox housing part 32) and a bottom support piece (a third gearbox housing part 33). The third gearbox housing part 33 as the bottom support piece could receive the motor shaft and the pinion 8 on the transmission rod 2, and is separated from the first gearbox housing part 31 and the second gearbox housing part 32 for receiving the transmission rod, the first and second transmission elements, the restoring spring, the impact block, the bushing and the output shaft, for facilitating the manufacture of the gearbox housing thereby. Meanwhile, the material of the gearbox is preferably metal, so as to dissipate heat and to keep good assembly accuracy.

The switch assembly of the present invention is mounted close to the spindle and is arranged within the scope of upper ⅔ of the whole length of the housing. Preferably, the switch assembly is arranged within the scope of upper ½ of the whole length of the housing 100, or within the scope of upper ½ of a length from the central axis Y of the spindle 4 to a bottom surface of the housing 100.

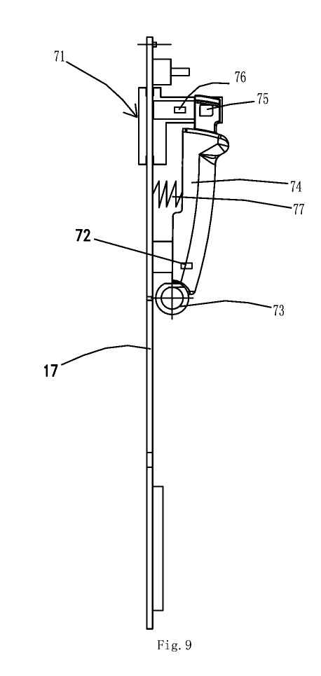

The switch assembly 7 comprises a speed governor 71, a main body 74 of the switch, an ON/OFF switch 72, and a hollow cylinder 73, wherein the speed governor 71 and the ON/OFF switch 72 are electrically connected to a PCB (Printed Circuit Board) 17 and preferably arranged directly on the PCB. Preferably, other control circuits of the tool are arranged on the PCB 17. The PCB 17 is elongated in shape whose both ends are secured within the housing by ribs protruding from the inner surface of the housing. In the housing, the PCB 17 does not need to be shielded, i.e. the PCB 17 can be directly arranged within the housing 100. In this embodiment, the PCB 17 is of one-piece structure, however, it could also be designed as two pieces or three piece structures in other embodiments. The main body 74 of the switch is formed with a groove 75 thereon, in which a speed adjustment button 76 of the speed governor is located. By pressing or releasing the upper portion of the main body 74 of the switch, the groove 75 could be controlled to drive the speed adjustment button 76 to slide on the speed governor 71 so as to adjust the motor to output different speeds. For illustrating the groove 75 and the speed adjustment button 76 clearly, the speed adjustment button 76 is shown to be removed from the groove 75 in FIG. 9. The main body 74 of the switch has a hollow cylinder 73 on its lower end. By a screw going through the hollow cylinder 73, the main body 74 of the switch is rotatably connected with the housing. The lower portion of the main body 74 of the switch is mated with the ON/OFF switch 72 that could be controlled for triggering by pressing or releasing the lower portion of the main body 74 of the switch. A switch spring 77 is arranged between the main body 74 of the switch and the PCB 17 for restoring the main body 74 of the switch when the user releases the main body of the switch. When the user presses the upper portion and the lower portion of the main body of the switch at the same time, the main body of the switch will trigger the ON/OFF switch and the speed governor simultaneously, and the angle impact driver will be started to work. When the user mistakenly presses the upper portion or the lower portion of the main body of the switch, only the ON/OFF switch or the speed adjustment button 76 is pressed and the angle impact driver will not be started to work so as to prevent a risk brought by mistaken operation.

Through the manner of arranging the circuit structure within the traditional switch box onto the PCB, the disadvantage that the traditional switch box occupies a large space is overcome and the housing of the tool is more compact. Therefore, the housing portion where the switch assembly is located has a smaller dimension in a radial direction substantially perpendicular to the direction of a holding axis of the tool by the user. Meanwhile, such arrangement of the switch assembly enables the main body of the switch to be placed closer to the working head so that a main holding position for the user is located in the scope of the upper ⅔, prefer ½, of the whole length of the housing, closer to the tool head. Thus, the users will have a better control feeling and the tool can be held more steadily during operation. At the same time, the holding position for an area of a hand between the thumb and index finger is designed to be concave which makes the holding more comfortable.

A power indicator light 24 of the angle impact driver is located on a rear side of the lower portion of the housing, which faces the user during operation. The lower positioned power indicator light allows the user to hold the upper portion of the housing for normal holding or to hold the lower portion of the housing for operations in a narrow working area without the power indicator light being covered by the hand of the user.

The head of the angle impact driver has an opening 23 formed on each of the left and right pieces of main body of the housing for exposing portions of the metallic gearbox housings located within the housing so that the heat dissipation is better.

It is to be understood that the above described embodiments are only intended for disclosing various principles, features, and advantages of the present invention and are not intended to limit the protection range of the present invention. Rather, one of ordinary skill in the art will understand that the present invention may be modified and improved without departing from the spirit and scope of the invention. Accordingly, the range of protection for the invention will be defined by the appended claims and their equivalence.

What is claimed is:

1. A portable angle impact tool comprising:
a housing;
a motor having a motor shaft located within the housing; and
a transmission mechanism which comprises a transmission rod extending along a longitudinal axis X, a spindle extending along an axis Y which is perpendicular to the axis X, an impact assembly driving an output shaft and connected with the spindle, a first transmission element positioned on one end of the transmission rod and engaging with a second transmission element positioned on one end of the spindle, and a pinion positioned on the other end of the transmission rod and engaging with a gear positioned on the motor shaft;
wherein in a direction of the axis Y the impact assembly and the spindle are located on one side of the second transmission element and the longitudinal axis X of the transmission rod is located on the other side of the second transmission element.

2. The portable angle impact tool of claim 1, wherein the first transmission element and the second transmission element are helical gears.

3. The portable angle impact tool of claim 1, wherein the impact assembly and the spindle have a common axis Y.

4. The portable angle impact tool of claim 1, wherein the transmission mechanism is located in an upper inner space of the housing, the motor is located in a middle inner space of the housing, and a battery for supplying power to the motor is located in a lower inner space of the housing.

5. The portable angle impact tool of claim 4, wherein the battery is detachably connected with the housing.

6. The portable angle impact tool according to claim 1, wherein a bushing is arranged on the output shaft for retaining a working component of the angle impact tool.

7. The portable angle impact tool of claim 6, wherein the working component is a screwdriver bit.

8. The portable angle impact tool of claim 1, wherein the impact assembly comprises an impact block mounted on the spindle, an impact restoring device located between the second transmission element and the impact block, and a hammer anvil connected with the output shaft.

9. The portable angle impact tool according to claim 1, wherein the motor shaft has a central axis Z which is parallel to the axis X of the transmission rod.

10. The portable angle impact tool of claim 9, wherein the transmission mechanism has at least a first position and a second position relative to the motor shaft, the first and the second positions being spaced by 90° around the axis Z.

11. The portable angle impact tool of claim 10, wherein the transmission mechanism is selectively secured in at least in the first and second positions relative to the motor shaft.

12. A portable angle impact tool comprising:
a housing;
a motor having a motor shaft arranged within the housing; and
a transmission mechanism which comprises a transmission rod extending along a longitudinal axis X, a spindle extending along an axis Y which is perpendicular to the axis X, an impact assembly driving an output shaft and connected with the spindle, a first transmission element positioned on one end of the transmission rod and engaging with a second transmission element positioned on one end of the spindle, and a pinion positioned on the other end of the transmission rod and engaging with a gear on the motor shaft;
wherein in a direction of the axis Y the impact assembly and the spindle are located on one side of the second transmission element and the first transmission element on the transmission rod is engaged with the second transmission element on other side of the second transmission element.

13. The portable angle impact tool of claim 12, wherein the first transmission element and the second transmission element are helical gears.

14. The portable angle impact tool of claim 12, wherein the impact assembly and the spindle have a common axis Y.

15. The portable angle impact tool of claim 12, wherein the transmission mechanism is located in an upper inner space of the housing, the motor is located in a middle inner space of the housing, and a battery for supplying power to the motor is located in a lower inner space of the housing.

16. The portable angle impact tool of claim 15, wherein the battery is detachably connected with the housing.

17. The portable angle impact tool of claim 12, wherein a bushing is arranged on the output shaft for retaining a working component of the angle impact tool.

18. The portable angle impact tool of claim 17, wherein the working component is a screwdriver bit.

19. The portable angle impact tool of claim 12, wherein the impact assembly comprises an impact block mounted on the spindle, an impact restoring device located between the second transmission element and the impact block, and a hammer anvil connected with the output shaft.
